(19) United States
(12) Patent Application Publication
(10) Pub. No.: US 2011/0276408 A1
(43) Pub. Date: Nov. 10, 2011

(54) Personality Profile Markers for Targeted Ads as a Method and a System

(76) Inventor: Sara Elizabeth Toole, Ponte Vedra Beach, FL (US)

(21) Appl. No.: 13/101,446

(22) Filed: May 5, 2011

Related U.S. Application Data
(60) Provisional application No. 61/331,452, filed on May 5, 2010.

(51) Int. Cl. G06Q 30/00

(52) U.S. Cl. 705/14.66

(57) ABSTRACT

The ad delivery system delivers personality profile typed ads to a user's Internet enabled devices (IED) when the device has a personality type marker-cookie (Ph-M data) thereon. Ad databases store ads designated by Ph-M type. The Ph-M data is loaded onto the IED when the user takes a test, the system classifies user's personality, and uploads Ph-M data onto the EID. Thereafter, when the user employs the IED, web servers recognize the associated Ph-M cookie-marker and the operative website server presents a personality typed ad to the user. The testing server may have an id in the Ph-M data. A centralized or distributed database system may be used. The ad system may be operable on a social network and ties to the user's social network profile. The system delivers effective and relevant ads based upon the user's personality type.

This is a regular patent based upon and claiming the priority of provisional patent application Ser. No. 61/331,452 filed May 5, 2010, the contents thereof is incorporated herein by reference thereto.

The present invention relates to a method and a system wherein a user engages a personality testing service on the Internet, the service provides a personality profile marker or profile type and the profile type marker is loaded as a cookie in the user's Internet enabled device or cell phone. When the user engages other web servers on the Internet, the specially configured web servers detect the personality type cookie and generate one or more ads uniquely classified according to that personality type. A social network can be combined with the targeted ad system to deliver customized advertising to users on the Internet that are both based upon the user's personality type, sometimes called “Meta type” or “Ph-Metatype” or “Ph-M data” and the user's search and buy history or the user's social network (FaceBook™) profile.

### BACKGROUND OF THE INVENTION

Online marketers are looking for ways to deliver relevant, customized advertising campaigns, often based upon a person's online surfing or buying behavior patterns (herein sometimes the “search-buy tracking data”), which are tracked by placing cookies on the user's computer. The cookies then convey information to ad servers, which allow the delivery of customized ads to the user. On social networks such as Facebook™, advertising can be customized based upon information a user provides in their profile (“social profile data”). In the offline world, advertising is often delivered based upon information that is stored about the user's purchases via credit cards and through signing up for loyalty programs, which track a user's purchases.

The problem is that none of these prior art methods address each consumer's personality profile, which influences the buying process and determines relevant psychological factors involved in a buying decision. Advertising offers cannot currently be customized to speak to different psychological types in a manner that would make ad offers more relevant or compelling, nor can the advertising offers be sorted or filtered according to which psychological types would be more interested and likely to respond (all brands have inherent qualities that appeal to different types).

Additionally, many consumers do not like the fact that their buying behaviors are being tracked both on and offline and find it invasive, which becomes a problem for advertisers.

### OBJECTS OF THE INVENTION

It is an object of the present invention to provide personality profile markers which are stored as cookies resulting in ads being delivered according to the personality profile of the user.

It is a further object of the present invention to provide a method and a system for providing personality profile markers associated with a user on user enabled Internet devices for the delivery of targeted ads.

It is an additional object of the present invention to provide revenue sharing and tracking for the delivery of the targeted ads.

### SUMMARY OF THE INVENTION

The method and system for delivery and distribution advertisements to a plurality of users on Internet enabled devices includes proving a collection of ads wherein the ads are grouped or specially designated with personality profile types. Ads for the same goods can have different content for different personality types. Additionally, different goods can be marked, designated or grouped according to different personality types. These ads are electronically presentable on Internet enabled devices and are maintained in Internet connected data ad stores. The method as well as the system generates a test and collects test results from the user's Internet enabled device to determine the user's personality profile type. The user's personality profile type is stored with a user identification or ID along with his or her personality profile type. The personality profile user database is maintained on and interconnected with the Internet. The system downloads from the user personality profile database a personality type marker (a cookie) to the user's Internet enabled device. Thereafter, when the user employs his or her Internet enabled device, web servers recognize the associated personality type marker from user's Internet enabled device. The operative website server presents an ad from the personality type ad group corresponding to the user's associated personality type. A testing server is provided for generating the test and collecting results. Multiple data stores may be deployed throughout the Internet with ad collections grouped into (or specially designated for) personality profile types. A centralized database or distributed databases may be employed to store a plurality of user IDs and the corresponding personality types. An upload module or program uploads personality type markers to the user's device. Typically the upload is generated by the test service. The trigger for the display of the ads is a short set of programs on the enabled website server that recognizes the cookie or marker from the user's Internet enabled device and responds to that cookie by pulling a personality type ad from the data collection of ads. The ads are displayed either on the first instance (the first web page) or, based upon the program on the designated website server, on the next display web page to the user.

The invention improves the online experience to deliver effective and relevant ads based upon the user's personality type which is referred to as “Ph-Metatype.” Ph-Metatyping is based upon a personality prototyping system known as the Enneagram. There are 9 primary types and 3 sub-types of Enneagram. Ph-MetaTyping may include elements of Neuro Linguistic Programming, or NLP, that may indicate certain preferences in how a person processes visual, auditory and kinesthetic information and makes decisions. A person's Ph-MetaType will be determined by an online or offline test. Currently, the user's test will be provided by the system operator or by other methods such as analyzing their online social profiles and behavior patterns (by analysis of search-buy data).

A person's Ph-MetaType is helpful in determining the person's core values and communication preferences. In making these distinctions about an individual, offers can be customized to become much more relevant and valuable to the user. Additionally, brands that match the core values and patterns of each personality type can be identified and targeted so advertising campaigns can be created to reach the personality types most likely to respond. For example, consider a new home safety product that is about to launch. The target audience for this product would be a Ph-MetaType 6: as this personality type is focused on security and safety. Given that there are only 9 primary Ph-MetaTypes (based upon the Enneagram system), if one can identify the core 12% of the population that will likely buy a product, it is very useful for marketing.

Additionally, using social media, if one can convert the personality types that are most likely to become evangelists for a particular product, then great economy in advertising costs can be achieved.

### BRIEF DESCRIPTION OF THE DRAWINGS

Further objects and advantages of the present invention can be found in the detailed description of the preferred embodiments which follow when reviewed in conjunction with the accompanying drawings in which:

FIG. 1 diagrammatically illustrates the system and process modules in a centralized system and, additionally in a decentralized system, for providing an advertisement distribution system and a method for distributing ads;

FIG. 2 diagrammatically illustrates a distributed advertising system (with testing services, databases, and revenue trackers) and an ad delivery process summarized over times t1 through t6, for presenting the advertisements based upon the user's personality type marker;

FIG. 3 provides general processing modules for the basic operation of the system;

FIG. 4 provides greater detail of the advertisement distribution system using personality types (generally referred to as Ph-M typing);

FIG. 5 diagrammatically illustrates a viral profiling process;

FIG. 6 diagrammatically illustrates a database management process for the centralized or distributed databases storing the plurality of user IDs and corresponding Ph-M personality types;

FIG. 7 diagrammatically illustrates module for the advertising process;

FIG. 8 diagrammatically illustrates the search-buy algorithm and the associated module;

FIG. 9 diagrammatically illustrates Ph-M testing and broad concept modules;

FIG. 10 diagrammatically illustrates the search and buy tracking and generation of the Ph-M personality types; and

FIG. 11 diagrammatically illustrates the cell phone or mobile Internet enabled device modules.

### DETAILED DESCRIPTION OF THE PREFERRED EMBODIMENTS

The present invention relates to the use of personality profile markers for delivering targeted ads to a user both as a method and a system. When implemented and deployed in a social network, the social network is combined with a system to deliver customized advertising to users on the Internet that are based upon the user's personality profile.

### General Concepts

The method and system in accordance with the principles of the present invention includes the following major elements. (1) The first step involves determining the user's Ph-MetaType, which is a system based testing event based upon the Enneagram personality system that may include some additional pattern-based typing distinctions based upon neuro linguistic programming (NLP). To determine the user's Ph-MetaType, the user takes a test on the Internet either on a social network having deployed thereon modules of the present invention, on a system controlled by the system operator or administrator, or via an application created for third party websites or mobile devices. (2) If a user takes the Ph-MetaType determinant test on the system operator's website, his or her Ph-MetaType will be stored in their social networking profile (see Facebook™), which can be publicly shared or kept private to share with select people. It will also become a part of the system operator's website database. The users Ph-MetaType result will also be stored via cookie technology (either standard or Flash-based), or using whatever technologies are developed and become standard for storing and conveying such information on the user's Internet enabled device that identifies a particular “type” of user to advertising servers for the purpose of delivering customized ads (stored either on the desktop; conveyed via the router or stored by the Internet Service Provider, etc.). (3) If the user takes the Ph-MetaType determinant test via an application that is housed on another website or mobile device, then the user's Ph-Metatype information will be stored on the user's computer or on their mobile device via cookie technology, or whatever technologies are developed and become standard for storing such information for the purpose of tracking and identifying a particular user as heretofore mentioned. The test taking user's IP address is stored in the system along with the test results and the user's name, email information and the results of their test along with any other information the system operator deems relevant in the system operator's website database. (4) On the system operator's social network, advertisers can customize advertisements to reach users on the operator's network based upon their particular Ph-Metatype. Instructions on how to customize ads may be given to advertisers, or the advertisers may use the system operator's consulting services to customize the ads. (5) The system operator may deliver customized ads throughout the Internet, not just to users on the system operator's social network, but via system operator ad servers that deliver advertising on third party sites, or via a cooperative sub-system operable with third party ad servers owned by other companies that will interact with the system operator's tracking system (cookies or otherwise as heretofore mentioned) that convey the user's Ph-Metatype information to the ad server. (6) The system operator may license its technology to other social networks such as Facebook™ to enable Facebook to customize advertising per the Ph-MetaType information based on a fee paid to the system operator. (7) Once the users Ph-MetaType information is conveyed to the ad server, there will be a minimum of 9 variations that are created based upon that information (there are 9 main enneagram types.) Additional parameters may include additional enneagram variations (there are 3 enneagram sub-types) and different hybrid variations of each of the 9 types to create many additional possibilities for customization.

Additional personality patterns that may be included as well for the purpose of delivering customized ads include such neurolinguistic patterns such as: (1) Does the user's psychological type move toward or away from what they want? (2) Does the user prefer to receive information visually, kinesthetically or via auditory input? (3) Is the user's personality type more active or more passive? (4) Does the users personality type make decisions based upon prioritizing their relationship to people, places, activities, information or material things?

A mechanism to determine the user's Ph-Metatype is essential, whether it is by a logical test delivered online or via mobile devices or whether it is a program that determines this information based upon user behavior pattern online (websites visited; purchases; search-buy tracking data) or information provided on existing social profiles (pre-populated user profile data on social networks).

It is important that the present system provide a mechanism that ties the user's Ph-Metatype information to a specific user that the Ph-Metatype follows the user's electronic foot steps during their online experience, whether trackable data is a cookie or another means. This is important for delivering customized ads on the Internet when a user is not on the system operator's social network.

Having a social network as a base for learning about Ph-MetaTyping is not required to determine the Ph-MetaType or to deliver customized advertising on the total Internet, as this can be accomplished independently of the system operator's social network via a testing process, tracking and ad delivery servers that read the tracking information as heretofore described. But a social network is a desired component in order to educate people on the benefits of learning more about Ph-Metatyping and to give them an interface that will allow them to customize their online settings to create a more customized user experience whether they are on the system operator's social network or the general Internet.

The need is to determine the user's primary Ph-Metatype in order to deliver customized advertising. Step one and two describe the process for determining the Ph-MetaType as being a logical test. The system operator may use additional or alternative methodologies to determine the user's Ph-MetaType other than a logical test. The test could also be a dynamic evaluation, i.e. an interactive game wherein the user's Ph-MetaType is determined based upon their choices and behavior in the game.

The user's Ph-MetaType may also be derived from analyzing user behavior and information revealed on the system operator's social network, other social networks and via user web surfing behavior and purchase history (search-buy data) without the need for any test at all. In this case, an algorithm which analyzes user online behavior patterns vis a vis the system operator's Ph-MetaTyping information.

The Ph-MetaType test is generally comprised of an evaluation mechanism: a logical test with yes/no or multiple choice questions. But it also could be an interactive game that evaluates user's choices, etc. and determines their Ph-MetaType; or a program that analyzes user data based upon their social profiles and online behavior. The user's Ph-MetaType will be determined based upon how the user responds to the stimulus presented (the test questions, the game, or their online behavior). The system operator provides the logical test key or the program that analyzes user behavior to determine the results.

If the test is taken on the system operator's social network, the user's test result is displayed in their profile and the user will be able to click on their Ph-MetaType number to see all of the users in the system operator's social network who have the same test result if the user chooses to share that information publicly. The social network will revolve around Ph-MetaTyping as a base for meeting people and learning how to interact with different Ph-MetaTypes in life. The social network may include a virtual reality component, i.e. Second Life™, where people can interact in real time to learn about Ph-MetaTypes. There may also be games where the user can test themselves on how to interact with different Ph-MetaTypes.

If the user's Ph-Metatype is determined via an application on a third party website or mobile application, then the user's Ph-MetaType information is conveyed to the system operator's website database via the program application and stored, along with the user's IP address, name, email address and any other information relevant for collection. The user will receive an invitation to join the system operator's website.

Once the user's Ph-MetaType has been determined, whether on the system operator's website or on a third party Website or mobile device, a cookie is placed on the user's Internet enabled device or mobile device that contains the user's Ph-MetaType information. The results of the user's Ph-MetaType test may also be stored by other current technological means for the purpose of conveying that information to the system operator's ad servers or third party ad servers so that the user can be identified and targeted specifically. Examples of alternate technology include Fovea™, which conveys information through a user's computer router in order to avoid the process of cookie purging.

On the system operator's website, the system operator offers information so that advertisers can customize their messages to suit the different Ph-MetaTypes. The system operator may have a program that allows an advertiser to submit advertising copy. The program will output a minimum of 9 variations to suit each particular Ph-MetaType. The system operator's website may offer consulting services on which of the Ph-MetaTypes will likely respond more to a particular brand's messages, along with managed advertising services where the system operator's customizes the ad for the advertiser.

Using the system operator's ad servers and in cooperation with third party advertising companies, the system operator will offer a service that reads the Ph-MetaType information as stored in the cookie or via other standard storage means and delivers customized ads to users both on the system operator's website and throughout the user's Internet surfing experience on websites that serve ads. The system operator will work with third party companies in the same way as described above: providing consulting services and information and a customized program that customizes the ads according to the Ph-MetaType information.

Computers execute the code that is required for most of the processes. Mobile devices will also use a mobile Ph-MetaType application and ad delivery sub-module. Desktop computers, servers, ad servers, databases and software that run on such systems including database software, server software and desktop software are utilized.

This technology can and may be deployed via the mail using a direct mail system and a database to determine which ad offers to deliver to particular people. In this scenario, the process of delivering customized ads would not be limited to the realm of Internet technology.

The key elements are delivery of a custom advertising product, creation of that product, a social network using that product, and an ad delivery service. Additionally, wearable merchandise can be created based upon a person's particular Ph-MetaType when conveyed the user's Ph-MetaType retail stores, or the Ph-MetaType information stored on a person's mobile device could convey this information to a retail store and the retail store could offer a customized retail experience based upon the user's Ph-MetaType.

In prior art current systems, the delivery of ads is limited by information that is explicitly revealed by a user via: their online history (the websites they visit online); their online or offline purchasing history, which is tracked; and information that is revealed via online social profiles.

Advertisers don't have a system for delivering relevant ads based upon a person's core values/psychological type. Once a person's Ph-MetaType is identified, the system operator can deliver relevant ads to the user based upon psychological drivers (i.e. what matters to the user) rather than their behavior or what they have revealed or done before, which is somewhat limited information.

The present process improves the likelihood that the user will find an advertising/marketing offer relevant. The process creates a personalized web experience that speaks in a voice that is relevant to each user and delivers offers that are valuable to the user. As a result, the user will perceive ad offers as being less hostile and irritating and begin to see them as a valuable resource of information because the ads are more personalized and customized offers.

Additionally, using this system, the system operator can help other companies to identify their own brand and product attributes using the Ph-MetaTyping system, and then target the users who are most likely to respond. This creates an ideal situation as offers are delivered to those who are most interested in those offers based upon their core personality type.

Key features include: a social network along with a data acquisition system and process to deliver customized advertising on the Internet to users that are both based upon a user's personality type, the Ph-Metatype, and are relevant to the user. Online advertising is currently based upon information that the user reveals about their interests as on social networks; or is based upon their behavior via their online history and purchases, which is stored and tracked. The system operator's process is based upon delivering targeted advertising campaigns that are keyed to established values and drivers of the individual's core personality, Ph-MetaType, which once identified, creates an opportunity to deliver a personalized online experience based upon ones core personality drivers. Additionally, is it possible that this method could provide the option to allow the user to self-select whether they would like to turn the customization on or off—so they could personalize their online experience as a preference.

### General Details of the System

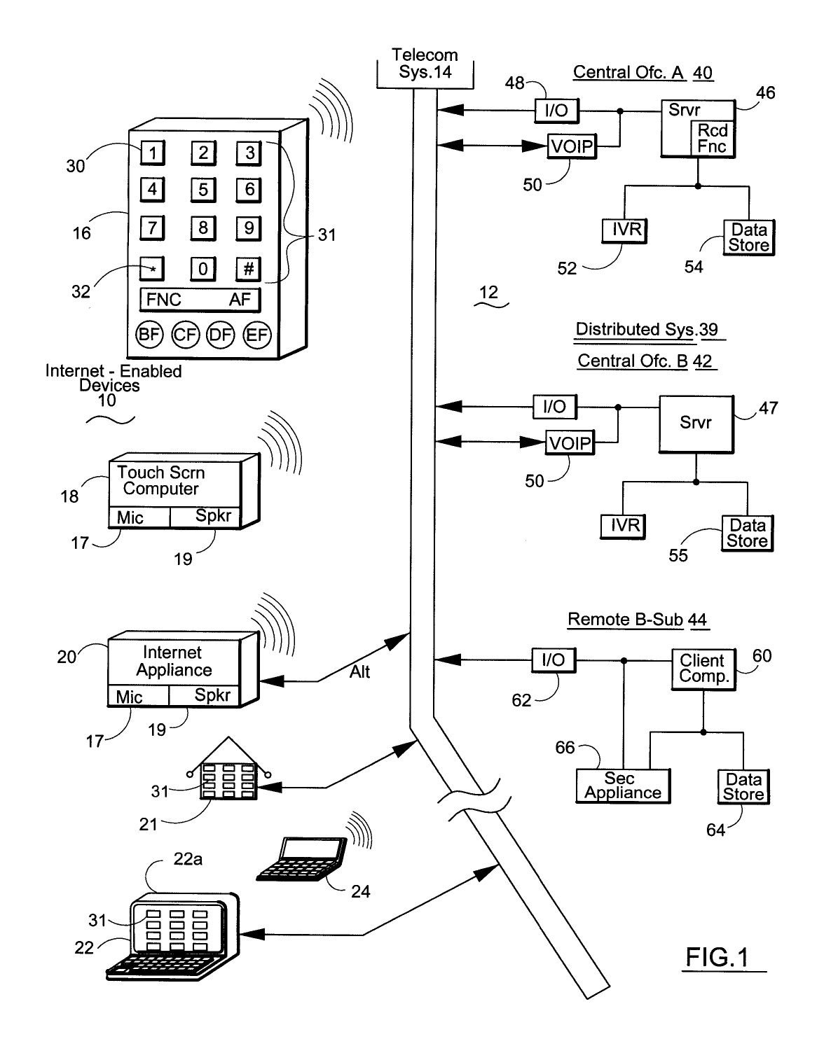

The general details of the system are discussed in connection with FIG. 1. The Table of Abbreviations at the end of this patent specification assists and the drawings provides an understanding of this invention. Similar numerals designate similar items in the drawings.

FIG. 1 diagrammatically illustrates the major system components for the present invention. Various Internet enabled devices 10 are shown as being communicatively coupled or connected to a telecommunications network 14. Further, network 14 enables communications between the Internet enabled devices 10 to one or more communications stations generally identified as station 12. As discussed later, station 12 may be a singular central office station 40 or may be represented by a distributed communications station made of sub-stations including central office B and remote station B-sub.

The present invention can be utilized in conjunction with various types of Internet enabled devices including cellular telephone 16 which may be a conventional cellular telephone with mechanical keys which are depressed by the user or may be a smart phone which has a relatively large display area which displays control key element icons such that the user activates keypad functions by touching the display area in the region where a key element is displayed. Sometimes, these key elements are identified by icons displayed on a screen (such as a computer monitor). Internet enabled devices also include touch screen computer 18, Internet appliances 20, land based telephone 21, enabled computers 22, and other types of cell phones or mobile telephones 24. These enabled devices 16, 18, 20, 21, 22 and 24 may include some type of speaker or audio announcing device as well as a microphone for capturing audio sounds in the vicinity of the enabled device. Touch screen computer 18 includes a display area that can be configured to show key icons such as those discussed below in connection with the key elements in enabled device The computer 18 may include a microphone 17 and a speaker 19. Land based telephone 21 is known to include a keypad showing key elements discussed later as key elements 31 on device 16. Computer 22 has a monitor 22a which shows key elements 31 (discussed later). Computer 22 will include some type of mechanism such as a mouse or a touch pad or a track stick which enables the user to select the key elements 31 on the computer display to enable the telecommunications and communications control events discussed later. Computer 22, as known by a person of ordinary skill in the art, sometimes includes speakers and microphones. Computer 22 is an Internet enabled device and may include a speaker and a microphone or the equivalent thereof. For example, a headset having a speaker and a microphone coupled to computer 22 results in an enabled device as computer 22. Cell phone 24 is a different representation of cell phone 16.

In order to simplify the explanation of portions of the present invention, these devices are sometimes collectively referred to herein as “Internet enabled devices.” The operation of the testing modules and the cookie download modules are generally applicable to all telecommunications enabled devices notwithstanding that the pertinent discussion only identifies a Internet enabled device. Testing modules may operate better on voice enabled computing devices (like cell phones) whereas reporting and tracking event modules may operate better on computers.

The Internet enabled device, cellular telephone 16, includes a plurality of actuatable control key elements 31. These key elements may be displayed as icons on a display screen or may be a mechanical keypad or keys on a key pad for the telecommunications device. Cell phone 16 may be a smart phone. With respect to actuatable control elements 31, these elements include keys or key icon such as the symbol “1” key element 30. Therefore, actuatable control key elements 31 include actuatable keys elements 1, 2, 3, 4, 5, 6, 7, 9, and 0 and control elements 31 include the * key symbol on key 32 and the # key symbol on key 34. Cellular telephone 16 if configured as a smart phone, includes other actuatable control keys such as function AF key 36a and other actuatable control key elements such as function BF key 36b and the function keys CF, DF, and EF. Typically on smart phones, these are icon or virtual keys on the phone display.

In any event, the cell phone or other Internet enabled devices 16, 18, 20, 21, 22 and 24, can be enabled to be in communication via telecom system 14 and with central office A 40 or the distributed station system 39. The distributed station system 39 generally includes a central office B 42 and a remote office or sub-station B-sub 44. In either event, several of the components in central office A, central office B and remote sub-station 44 are generally similar.

In general, central office 40 includes a server 46 (more properly designated as a computer with a processor, loaded to perform designated functions on command) which is coupled to telecom system 14 via an input/output device, module or functional element 48. Audible instructions may be provided to the cell phones and enabled devices 16, 18, 20, 21, 22 and 24 by the central office 40 via interactive voice response or IVR 52. The VoIP or voice over internet protocol unit 50 may enhance the telecomm session routines and the testing module. VoIP module 50 may be connected to telecom system 14 via input/output unit 48. The interconnection of various components to the telecom system is known to persons of ordinary skill in the art. Server computer processor 46 at central office 40 also includes an interactive voice response IVR module 52 which can be used in the testing modules. Central office 40 also includes a data storage module 54 for storing compiled test results and gathering cookies and retrievable data from the Internet enabled devices when later activated by the user to search the web or buy goods or services. The server computer 46 has a recording module (RCD fnc, a record function process) which enables the server in conjunction with a machine translation unit to record and store in data store 54 the (a) test results and (b) the compiled tracking reports and search-buy data from each user and each Internet enabled device. Server 46 has functional modules and computer program elements that enable the recording of signals and enable the audio presentation instructions and tests from in data store 54 and record responses. These are used in the test modules. Further, server 46 utilizes the IVR module 52 to present to users at the cell phone 16 and other enabled devices audio instructions (test questions) based upon information stored in data store 54.

Distributed system 39 is similar in many respects to central office station 40. However, central office 42 includes server computer 46 and data store 55. Personality markers, cookies, and search-buy data can be stored at the remote sub-station 44 in data store 64. The main personality profiles can be stored in the central office A 40, and small, limited operational personality profiles and search-buy data can be stored in the remote sub-station 44 and data store 64. Supplemental or “short” tests can be presented and recorded at the office B 42 location. Supplementation data can be uploaded to main central data store 54 periodically.

Since the operation described herein can be carried out either as singular central office location 40 or distributed system 39, which includes central office 42 and remote sub-office 44, persons with ordinary skill in the art recognize that additional services can be provided by widely distributed and dispersed systems to activate various supplemental services (testing, supple testing, search-buy tracking data, etc.). These functions can be distributed between central office 42 and remote office 44.

### Specific Details of the System and Method

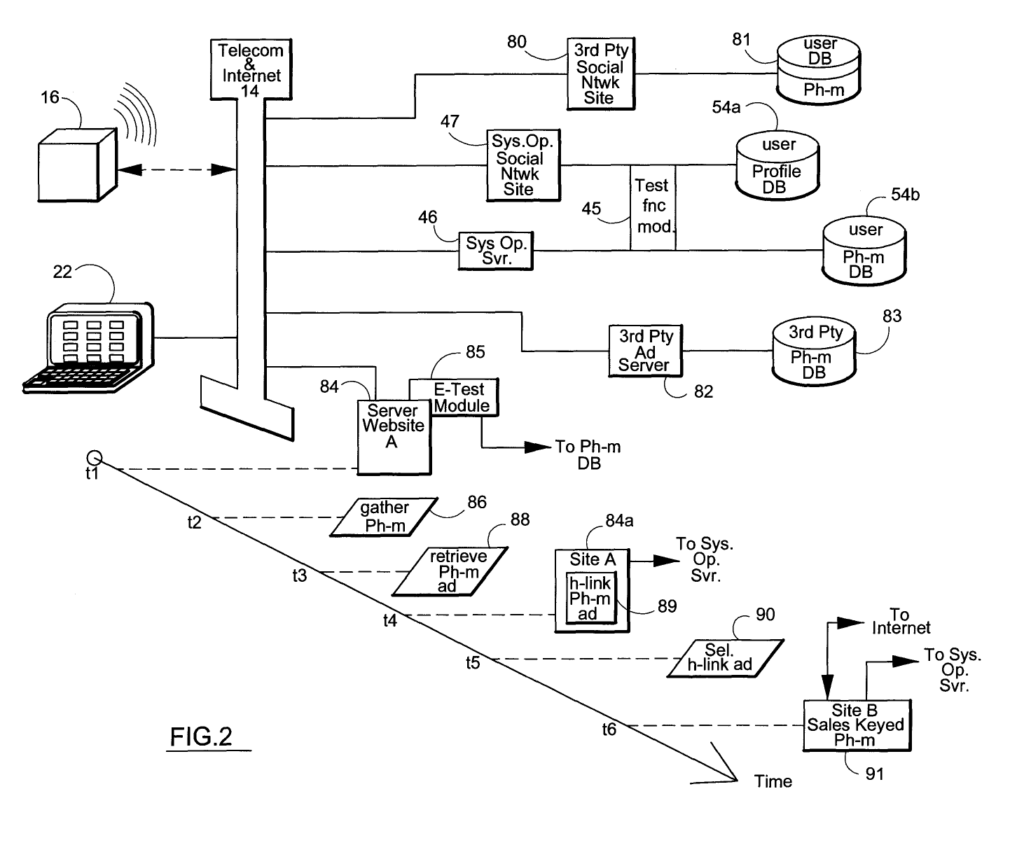

FIG. 2 diagrammatically illustrates the centralized and the decentralized advertisement distribution system as well as a summarized time line process at times t1 through t6, providing a general overview of the method of distributing targeted ads to the user. The Internet enabled device, such as a user's cell phone 16 or an Internet connected computer 22, is connected to a telecommunications system and ultimately to Internet 14. The targeted ad system can be implemented on several types of client-server computer systems. For example, the system operator (Sys. Op.) may provide a server 46 or may operate a social network server and website 47. As is known on social network sites, all visits and purchases (“buy” data) are logged into the user's social network profile. Alternatively, the targeted ad method and system can be provided by a third party social network site 80 such as Facebook™ or Myspace™. Further, the method or a part of the method and the computer program can be provided by another third party ad server website A 84 which includes an E-test or Enneagram test (E-test) module 85. E-test module 85 provides the personality profile Metatype Ph-M data to the Ph-M database at either third party social network user database 81, system operator social network Ph-M database 54B or system operator server Ph-M database 54B or third party ad server Ph-M database 83. As discussed later, third party social network site 80, system operator social network site 47, system operator server 46 or website server A 84 can provide the E-test to the user when he or she signs onto one or more of these websites. The Enneagram test (E-test) is well known and a test function module 45 (associated with social network site 47 and system operator server 46) can be deployed by social network site 80 as well as third party ad server 82 and server website A 84. After the test is processed by the user on one of these websites, the test results identify personality profile data for the user and this Ph-M data is stored with in user identification database 81, 54A, 54B or 83. If the test is delivered to the user via server website A 84, the personality type associated with the user is sent to a Ph-M database 81, 54B or 83 such that the user's activity can be tracked. The ad system may also track the testing server 84. After delivery of the test, a cookie or a personality type marker associated with the user is either uploaded or downloaded (pushed or pulled) to the Internet enabled device 16, 22 or any of the Internet enabled devices discussed above in connection with FIG. 1.

The ad delivery process is summarized by the steps at times t1 through t6. The time line operation t1 through t6 reveals how the advertisement distribution system and method reacts each time the user engages a website on Internet 14. When the user visits website A with server 84, the initial connection by server 84 delivers a web page to one of the Internet enabled devices 16, 22. If a cell phone 16 is utilized, the server 84 may have a mobile version of the program and web page. If computer 22 is utilized by the user, server 84 would have the more common website presentation to the user. At subsequent time t2, server 84 gathers the associated personality type marker Ph-M from the Internet enabled device 16, 24. The cookie is retrieved from device 16, 22. This is noted in step 86. At time t3, the server 84 retrieves an ad associated, grouped or designated by the personality type Ph-M matching the user's type either from third party ad server 82 or one of the other ad databases associated with social network 80, social network 47 or system operator server 46. In other words, ads for the same goods may have different ad content for different personality types. Otherwise, different goods may be grouped according to different personality types. As used in this specification and in the claims, the term “grouped” refers to uniquely tagging or identifying or designating certain ads to certain distinct personality profile types. The ads themselves may not associated in the same part of the database (or they may be) but each ad has a distinct personality profile type. Otherwise, based upon speed of operation and other technical aspects, different goods may be grouped into common distinct personality types. As used in the specification and the claims, the term “goods” refers to hard goods offered for sale or lease to the user as well as services offered for sale or lease to the user.

The following Ad Personality Table shows different goods (“fast cars”) associated with different personality types as well as the similar goods (“car ad”) having different ad content for different personality types.

Ad Personality Table

Car ad
Version 1 - reformer, idealistic
Version 2 - achiever
Version 3 - loyalist
Fast car model Brand A
only achiever
Fast car Model Brand B
only achiever
Fast car Model Brand C
only achiever

For example, the “car ad” may be an advertisement for a current type and model of car such as a Ford Focus. That Ford Focus car may have three ad versions, version 1, 2 and 3 each having ad content that is different based upon the personality profile type reformer, idealistic (version 1) or achiever (version 2) or loyalist (version 3). Otherwise, different goods such as fast car model brand A (Corvette) may be displayed to an achiever as well as fast car model brand B (Maserati) displayed again to the same achiever.

The delivery of the unique or targeted ad to the user may be presented when the user first lands on server website A 84 if the website can quickly gather the personality type cookie or marker from Internet enabled device 16, 22. Alternatively, if the server A cannot obtain or recognize the cookie or marker on device 16, 22, an alternative mechanism is described below in the Alternate Ad Trigger Routine Table.

Alternate Ad Trigger Routine Table

1. At website A, gather user's Ph-M data
2. Retrieve a personality profiled ad from an ad server or back office
data store on website A
3. Upon the next displayed website page or upon segmented web
page presentation, display the personality profiled ad
4. Tracking ad display
5. Tracking click thru from ad
6. Tracking vendor sales

In the alternative process, the targeted or directed profiled ad is presented to Internet enabled device 16, 22 at the second loading of the web page or subsequent partial loading of the first page. It is known that portions of the web page are loaded at different times. Therefore, reference to the “next displayed web page” on the Alternative Ad Table may refer to sequential loading of portions of the web page. In this manner, initial web page content is served up to device 16, 22 by website A 84 to keep the user's interest and the personality profile target ad is delivered before the entire contents of the web page is displayed.

After the targeted ad is retrieved from the ad server 82 in step 88 at time t3, the website A displays to the user the personality driven Ph-M ad 89. Also the Ph-M ad 89 includes a hyperlink (H-link) available to the user at device 16, 22. This occurs at time t4. At time t5, if the user is interested in the goods advertised, the user selects hyperlink at step process 90 at time t5. At time t6, the technical process has shifted user device 16, 22 to website B which advertises the sale of the good shown in Ph-M ad 89. Sales made to the user at site B in step 91 are tracked by the system operator server 46, or the social network sites 80, 47 or the third party ad server 82.

Therefore, the system includes a plurality of ads and certain ad data collections either operated by third ad server 82 as ad collection 83 or operable by social network 80 or social network 47. As is known, social networks 80, 47 have their own ads uniquely associated with the social network. Therefore, the ad server database with the ads are uniquely associated with the social network sites. These ad server databases have ads grouped into or designated by personality profile types. Ads for the same goods may have different content for different personality types. Alternatively and in addition thereto, different goods may be grouped or designated according to different personality types. When the personality type marker or cookie on device 16, 22 is identified, the corresponding Ph-M ads are displayed to the user.

The upload mechanism for the personality type marker from devices 16, 22 is well known since cookies are currently transferred to and stored in Internet enabled devices 16, 22 and also retrieved by website servers 46, 47, 80, 82 and 84. Currently, it is known that website servers 84 can recognize Internet protocol (I. P) addresses and geographically targeted ads are sent to devices 16, 22 based on geo-tracking of IP addresses. Therefore, once the system 46, 47, 80, 82, 84 obtains the personality type marker or cookie from device 16, 22, the identified servers can access an ad collection database, retrieve the personality profile ad and deliver that personality profile ad to the user at device 16, 22. The process module for triggering the display of a personality type ad is similar to the triggering of geographically unique ads now delivered to users at devices 16, 22 based upon the I.P. addresses associated with devices 16, 22.

The mechanism and module for interactively testing the personality of the user at devices 16, 22 (or any of the Internet enabled devices discussed in connection with FIG. 1) employs common Q and A mechanisms. The tests are discussed later herein. The term “uploading” generally refers to one of the servers pushing information or items to devices 16, 22. The term “downloading” also refers to the pushing of data to devices 16, 22.

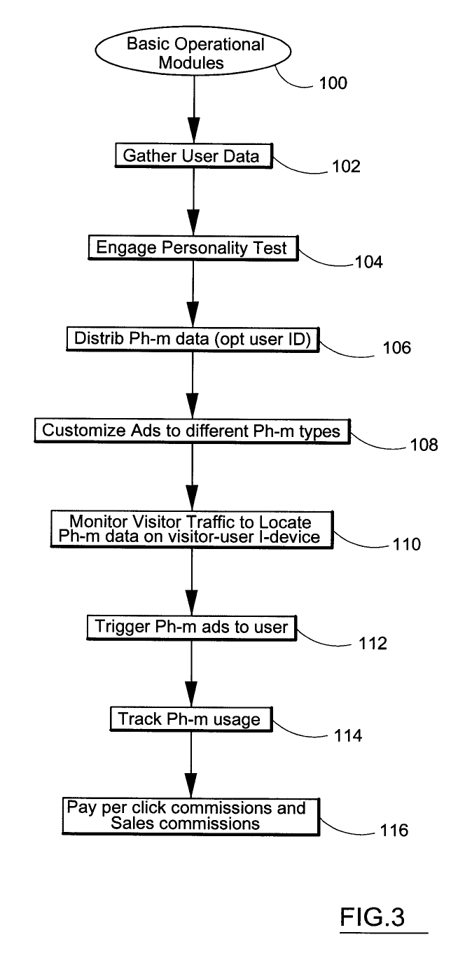

FIG. 3 diagrammatically illustrates basic operations 100 and the modules used in connection with the present method and system. Step 102 recognizes that user data, such as user I.P. address, name, address, email, cell phone data, is collected by one or more of the servers discussed above in connection with FIG. 2. Personal identifiable data (PIN data) may be limited to servers 46, 47 and 80 since those servers are more secure and have greater privacy protection for the user. Step 104 in FIG. 3 engages a personality test and delivers that E-test to the user. The test is delivered as shown as test 85 and server 84 and, more commonly, the test is delivered by servers 46, 47 or 80. The test results are obtain from the user device 16, 22 and stored in the user database 81. Personality type data or Ph-M data is created based upon test results and the Ph-M data is stored in database 54B or user database 83. Generally, database 83 is an ad configured database and not a user profile database. In other words, uniquely configured and structured personality type ads are stored in database 83 to be distributed by various websites including website A 84.

Once the user has been recognized by the personality test in step 104, the personality type data or marker associated with the user is then distributed throughout the ad collection databases. Optionally, the user id or a subset of the user id (a user unique identifier) may be distributed to the ad databases in step 106.

Returning to personality test 104, various enneagram tests are available. The following tables provide locations and summaries of these tests.

Available Enneagram Test Table E-1

(A) At: http: //www. eclecticenergies.com/enneagram/test.php
Enneagram that determines enneagram plus wing configurations - http: //www.
eclecticenergies.com/enneagram/dotest.php
Enneagram with instinctual variant determination -http: //www.
eclecticenergies.com/enneagram/test-2.php
Author is Ewald Berkers. Published about 2003.
(B) At: http: //www. enneagraminstitute.com/Tests_Battery.asp
Multiple tests:
FREE RHETI SAMPLER (Short enneagram test) -http: //www.
enneagraminstitute.com/dis_sample_36.asp
Long RHETI enneagram test (just main enneagram) - http: //www.
enneagraminstitute.com/moreinfo.asp
An Instinctual variant test (just instinctual variant) - http: //www.
enneagraminstitute.com/ivq.asp
Authors are Don Riso and Russ Hudson. Publication date about 1998
(C) At http: //www. similarminds.com
Four enneagram tests plus additional personality tests:
Enneagram instinctual variant test http: //similarminds.com/cgi-bin/variant.pl --
Enneagram short test -- http: //similarminds.com/test.html
Enneagram long test -- http: //similarminds.com/advtest.html
Enneagram plus myers briggs test http: //similarminds.com/cgi-bin/newembj.pl
List of many personality tests -- http: //similarminds.com/personality_tests.html
Author is Tim Flynn. Date of publication unknown.
(D) At http: //www. enneagram.net/tests/
Four (4) tests:
Enneagram Instinctual Subtypes Test
Enneastyle Questionnaire Enneagram Test
The Enneacards Enneagram Test
The Enneacards Sampler Enneagram Test
Authors are Katherine Chernick Fauvre and David Fauvre. Date of publication unknown.
(E) At http: //www. 9types.com/
Ane enneagram test
http: //www. 9types.com/newtest/index.php
Author and publication date is unknown.
(F) At http: //www. enneagramworldwide.com
Two enneagram tests:
Primary enneagram type test:
http: //www. enneagramworldwide.com/enneagram-test/index.php
Instinctual subtype test --
http: //www. enneagramworldwide.com/explore-the-enneagram/instinctual-subtypes/
Authors are David Daniels, MD, and Virginia Price, PHD. Publication about 2006.
(G) At http: //www. testcafe.com/enn/
One enneagram test:
http: //www. testcafe.com/enn/enn.html
Author is unknown, publication date is 2001.
(H) At http: //www. noanxiety.com/tests/enneagram-test.htnil
One enneagram test:
http: //www. noanxiety.com/tests/enneagram-test.html
Authors and date of publication unknown.
(I) At http: //www. enneagramspectrum.com/ ; http://www.wepss.com/
One enneagram test:
Primary enneagram test that determines wing type:
http: //www. wepss.com/tool_7.html
Author is Jerry Wagner, Ph.D. and website copyright is 1999.
(J) At http: //pstypes.blogspot.com/2009/11/pstypes-enneagram-test.html
One enneagram test:
Primary enneagram test:
http: //pstypes.blogspot.com/2009/11/pstypes-enneagram-test.html
Author unknown; date of publication 2009

Electric Enneagram Test (Table EE-1)
http: //www .eclecticenergies.com/enneagram/dotest.php
Possible Results

Type 1
Type 2
Type 3
Type 4
Type 5
Type 6
Type 7
Type 8
Type 9
Wing 1w2
Wing 1w9
Wing 2w1
Wing 2w3
Wing 3w2
Wing 3w4
Wing 4w3
Wing 4w5
Wing 5w4
Wing 5w6
Wing 6w5
Wing 6w7
Wing 7w6
Wing 7w8
Wing 8w7
Wing 8w9
Wing 9w8
Wing 9w1

Enneagram Institute RHETI and RHETI Sampler (Table EE-2)
http: //www. enneagraminstitute.com/Tests_Battery.asp#RHETISampler
Possible Results

Type 1
Type 2
Type 3
Type 4
Type 5
Type 6
Type 7
Type 8
Type 9

Enneagram Institute Instinctual Variants
Questionnaire (IVQ) (Table EE-3)
http: //www. enneagraminstitute.com/Tests_Battery.asp#RHETISampler
Possible Results

| RHETI and RHETI Sampler | Variants |
|---|---|
| Type 1 | self preservation |
| Type 2 | social |
| Type 3 | sexual |
| Type 4 | self preservation |
| Type 5 | sexual |
| Type 6 | social |
| Type 7 | social |
| Type 8 | sexual |
| Type 9 | self preservation |
| | social |
| | self preservation |
| | sexual |
| | sexual |
| | self preservation |
| | social |
| | sexual |
| | social |
| | self preservation |

Results of RHETI Test (Table EE-4)

1. THE REFORMER
The Rational, Idealistic Type: Principled, Purposeful, Self-Controlled, and Perfectionist
2. THE HELPER
The Caring, Interpersonal Type: Demonstrative, Generous, People-Pleasing, and Possessive
3. THE ACHIEVER
The Success-Oriented, Pragmatic Type: Adaptive, Excelling, Driven, and Image-Conscious
4. THE INDIVIDUALIST
The Sensitive, Withdrawn Type: Expressive, Dramatic, Self-Absorbed, and Temperamental
5. THE INVESTIGATOR
The Intense, Cerebral Type: Perceptive, Innovative, Secretive, and Isolated
6. THE LOYALIST
The Committed, Security-Oriented Type: Engaging, Responsible, Anxious, and Suspicious
7. THE ENTHUSIAST
The Busy, Variety-Seeking Type, Spontaneous, Versatile, Acquisitive, and Scattered
8. THE CHALLENGER
The Powerful, Dominating Type, Self-Confident, Decisive, Willful, Confrontational
9. THE PEACEMAKER
The Easygoing, Self-Effacing Type, Receptive, Reassuring, Agreeable Complacent

Table E-1 provides a location for various Enneagram tests. Table EE-1 provides possible results for the E-test. Table EE-2 provides a sample of possible results. Table EE-3 provides a sample with variants of the results. Table EE-4 presents the results for RHETI and a short description of those types. Cookies may be Ph-M1, 2, . . . 6 or may be listed as in Table EE-1.

Returning to FIG. 3 in step 106, the advertisements from ad databases must be keyed to the profile types since the types trigger the display of the ads. These ads are found throughout various ad databases on the Internet. Step 108 customizes the ad to different personality types. These various personality types are discussed above in connection with the Enneagram test tables. Step 110 monitors the visitor traffic at various websites on the Internet (for example website A at server 84) and also monitors the personality type marker or cookie and Ph-M data on the user enabled device 16, 22. Step 112, upon detection of a personality type marker from Internet enabled device 16, 22, triggers a personality type ad from an ad database. The triggering step 112 results in the presentation of the ad to the user at device 16, 22. Tracking step or module 114 provides a usage or monitoring function. After recognizing the associated personality type maker from device 16, 22 and presenting the ad associated to that identified personality type, it is important to track the use of the personality type ad. Step 114 notes that a tracking event arises and the system generates a tracking report. That tracking report is sent to system operator server 46 as well as third party ad server 82. As a result of tracking and monitoring result step 114, in step 116, the advertiser pays a per click commission when the ad is displayed, a second per click commission when the user on device 16, 22 selects hyperlink 89 at time t4, and, if sales occur on website B 91 at time t6, a further sales commission. The ad servers 82 currently provide tracking for displayed ads, for click on or click through traffic, as well as commissions based on sales. These items are tracked, reports are generated and revenue is shared by the system operator, the third party ad server and the social network sites 47, 80. The testing server may also be compensated. In that process, the Ph-M cookie includes a testing server id.

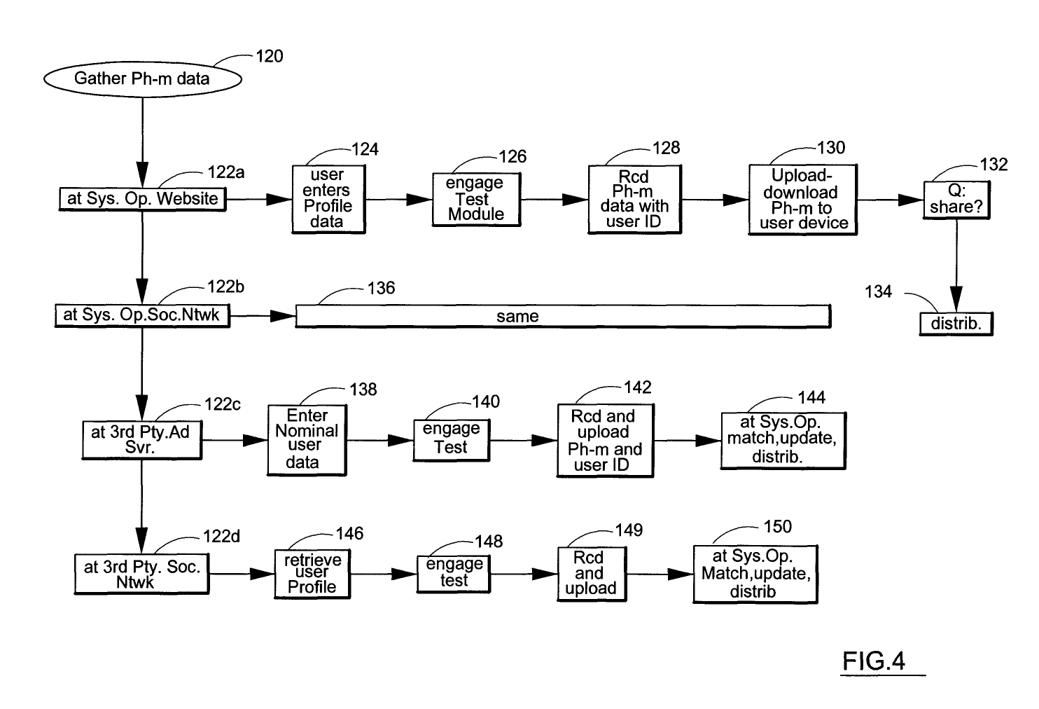

FIG. 4 provides in greater detail a breakdown of the input phase to gather the personality data from the user. Ph-M gathering process 120 includes personality testing input operations 122A at the system operator website 46, personality testing process 122B at system operator social network 47, testing by third party ad server 82 as process step 122C and testing and profile data input by third party social network site 80 as process step 122D. From the system operator website 45 and process 122A in step 124, the user enters certain profile data into the system. This profile data typically includes name, address, cell phone number, email and other personal identifying (PIN) data. In step 126, the system operator server 46 engages the test module for the E-test described earlier. In step 128, the operator server 46 grades the E-test, identifies the user's personality profile and records the personality type with the user's id profile. The user profile database 54A may be separate from or may be combined with the user Ph-M database 54B. In any event, the user profile type Ph-M data is associated with the user id in step 128. In step 130, an upload or download of the personality type marker is made to the user's device 16, 22. Currently, these marker items are called cookies. If in process input step 124 the user enters his or her cell phone number, the cell phone number may be part of the user id such that the system can recognize the ANI or Automatic Number Identification of cell phone 16 and then associate the personality profile data Ph-M to the user activating the cell phone resulting in the download of personality type ads to cell phone 16. The ANI of the cell phone uniquely identifies the user. If the ANI is linked to Ph-M data, targeted ads are displayed. These ads may be audio only or may be audio and visual or may be only visual.

There are three (3) ways to deliver target Ph-M ads. First, the Ph-M cookie triggers a corresponding Ph-M ad. Second, the ANI links the caller to the user id database (or a truncated database) listing the ANI and the Ph-M type, then the Ph-M ad triggers a Ph-M type ad. Third, the user's device provides a user id (for example, when surfing a social network, the user's id profile is open) and the user id is used to locate the user's Ph-M type. The corresponding Ph-M ad is then delivered to the user.

In step 132, the user is presented with an option to share his or her personality type with other people. This generally occurs on social network sites 80, 47. If the user affirms or agrees to share his or her personality type, this personality type is linked to other similar personality types (or other complementary personality types) in step 134. In a social network, the same personality types may be further defined by certain geographic regions based upon the I.P. addresses of devices 16, 22. If cell phone 16 is utilized, geographic tag data from the cell phone may be used to identify other personality types of the same or similar manner. Therefore, when the user returns to social network 47, 80, personality types of a similar nature (or complementary nature, as appropriate) may be identified (friended”) together. Currently, programming processes and modules are available to achieve this “grouping” through geographic tagging but not based on personality types. Four Square (TM) computer programs and websites provide this geographic tagging. Therefore, this program module is easily extended to personality type tagging based upon the processes and descriptions herein.

Regarding the input operation at social network site 47 operated by the system operator, input process 122B is the same as noted in process 136. In other words, step 124 through 134 are employed in similar process 136. At input process 122C, when the third party advertiser server 82 gathers the information, step 138 notes that only nominal user data is obtained. For example, the user name and email address may be obtained as “nominal” user identification. Step 140 engages the personality test, grades the tests, assigns Ph-M type and presents Ph-M markers to devices 16, 22. The test results are gathered and stored with the user id data in step 142. A record is made and the record is distributed as noted in step 144 to the system operator or the social network 47 or network 80. In this manner, the user's personality type can be updated into servers and databases 46, 47 and 80. A widget may be employed in connection with social network sites 47, 80 such that the user's personality type is automatically matched to the pre-loaded user profile in databases 54A and 81. At input process 122D, in step 146, the system retrieves the user profile. Since a social network is employed, social networks typically have full data profiles on their users. Step 148 engages the personality test and collects the test data from the user. Step 149 records that personality type with the user's profile and uploads and distributes the user's profile type to various ad severs such as ad server 82, 83. In step 150, at the system operator 46, 47, a match is made to the user data profile 54A and the user's personality profile is updated in database 54B. If the user's personality is new to the system, items are distributed through ad system 82, 83.

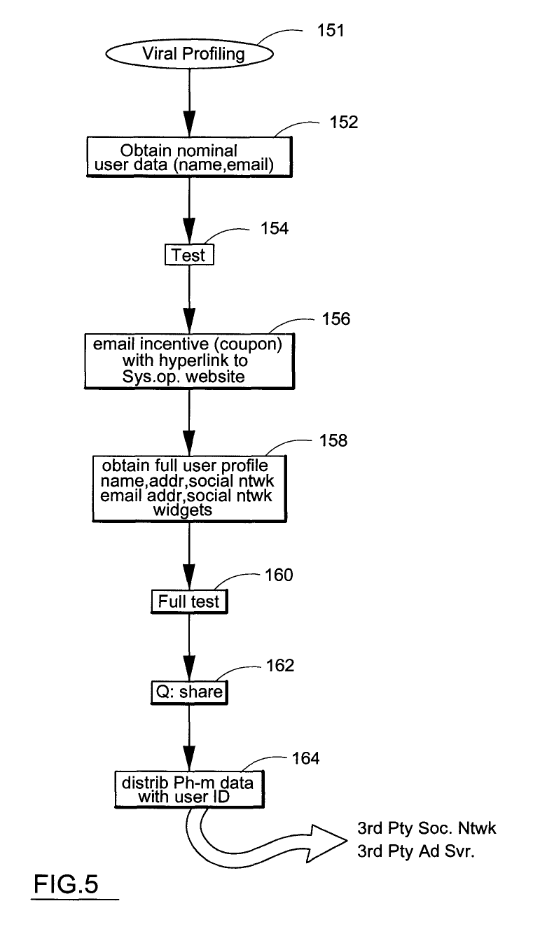

FIG. 5 diagrammatically illustrates a viral profiling process which can be used in connection with the present invention. Profiling process 151 begins at step 152 which obtains nominal user data such as name, I. P. address and email only. See server 84 process above and “nominal” data collection. The test is administered in step 154. In step 156, system operator server 46, after obtaining the data, for example, from server website A 84, sends out an email to the user. The email may include a coupon or any other incentive to join the system operator social network 47 or, generally, a log in hyperlink to system operator server 46. The email incentive and coupon should include a hyperlink to the system operator website 46, 47. In step 158, the user goes to the server 46, 47 via H-link, and the system operator obtains the full user profile name, address, cell phone number, email address and social network widgets. The coupon then is validated or reward points assigned. In this manner, when the user inputs and logs into and fills in the profile in system operator server 46, 47, that information is populated back into third party social network site 80 and network 81. A full test is administered and graded in step 160. Test results are stored. In step 162, the user is asked whether he or she wants to share the profile data with others on the system operator server 46, 47. In step 164, the personality data is distributed with or without the user id. This distribution occurs on third party social network 80 and possibly on third party advertiser server 82.

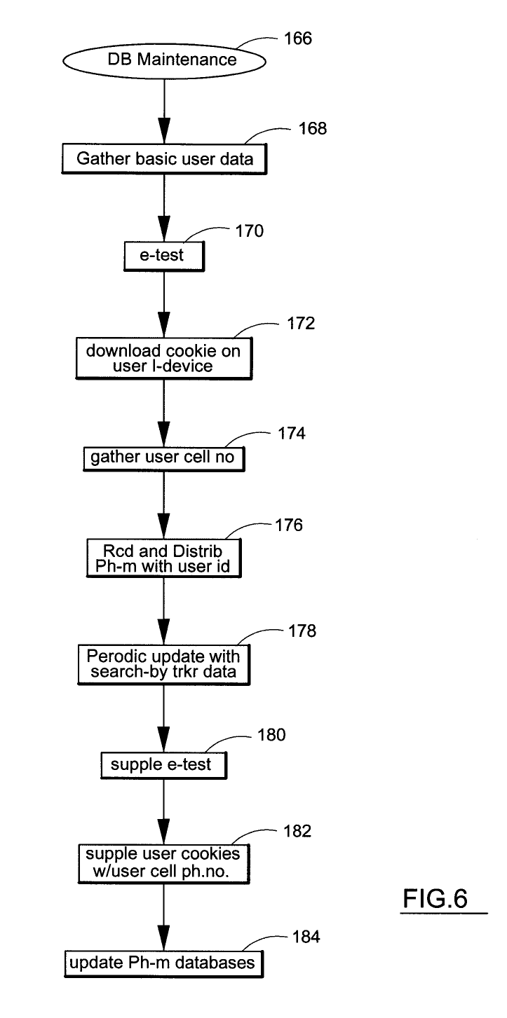

FIG. 6 diagrammatically illustrates the major process modules for database management and maintenance 166. In step 168, the system gathers basic user data. In step 170, an E-test is delivered to the user. In step 172, the personality type marker or cookie is logged into user device 16, 22. In step 174, the system gathers the user's cell phone number from Internet enabled device 16. The cell phone number ANI is recorded in one of the user id databases 54A, 81. The cell phone number and personality type may be further distributed to ad database 83.

In step 178, a periodic update is made based upon the search-buy tracking information listed on device 16, 22. It is known that computers track the history of the user's travels and visits on the Internet. This search history is used in connection with the present invention. When the user buys certain things, there may be cookies or other information on user devices 16, 22 which note a “buy” event. Further, when the user engages site B 91 in FIG. 2, a buy tracking data is delivered to system operator server 46, third party ad server 82 or networks 47, 80. This information is updated by the system operator databases 54A, 54B. If operated exclusively on social networks, social network database 81 is updated with this search-buy tracking data.

In step 180, a supplemental E-test is provided to the user. This may be periodically provided to the user to update the personality type database or data provided at various websites dependent upon which website has more interest in the user's activity. In step 182, the cookies or the personality type is supplemented or updated on user devices 16, 22. Also, the user's cell phone number ANI from device 16 is updated in records 54A, 81 and database 53. As is known, if the user is activating cell phone 16, the cell phone ANI (Automatic Number Identification) is logged into ad content database 83. This personal identifying data (the cell phone number) can be linked to the personality type of the caller by a database 54B, 81 to generate a personality type ad from ad database 83. Otherwise the ANI is stored with the Ph-M data. Subsequent to the presentation of that personality type ad, if the cell phone 16 is still enabled, a cookie could be placed on cell phone 16 indicating the personality type of the user operating cell phone 16. Step 184 updates the Ph-M databases for the various personality types.

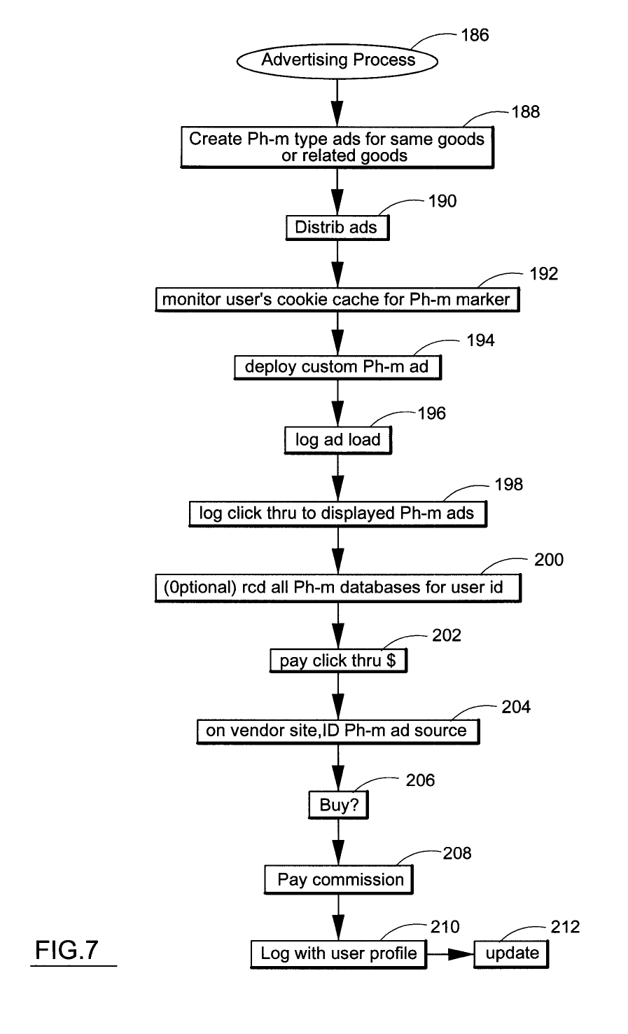

FIG. 7 discloses advertising process 186. In step 188, ads are created for different personality types for the same goods or are created for related goods associated with a particular personality type. Step 190 recognizes that personality ads are distributed throughout the Internet on ad databases 83. Step 192 monitors the cookies or personality markers on user devices 16, 22. These cookies or markers are in caches. In step 194, customized personality type ads are deployed to devices 16, 22. Step 196 logs or records the uploaded ads sent to devices 16, 22. This log could occur at third party ad server 82 or on sales site 91. Step 198 logs the click through data based upon the displayed personality type ads. Step 200 is an optional step which records the user id in all personality ad type databases the user I.D. Step 202 is a revenue monitor and revenue sharing step. In other words, advertisers pay a click through charge and commission to the system operators as well as the ad servers. In step 204 on the vendor site B, the identified personality type and user id is located. More importantly, the source of the ad from third party ad server 82 is identified. Step 206 notes and questions whether the user has bought merchandise at site B 91. Step 208 pays a commission based upon the “buy” at site B. In step 210, the information is logged or recorded with the user id profile 81, 54A, 83. Step 122 updates all databases.

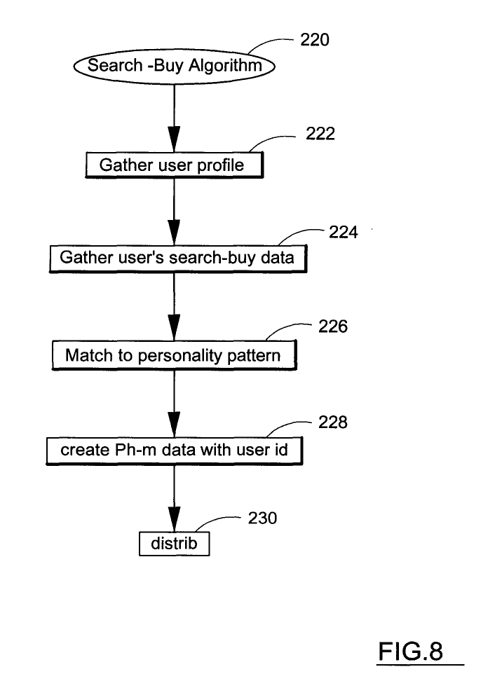

FIG. 8 diagrammatically illustrates a search-buy algorithm 220. Since it is known that the Internet history for devices 16, 22 is customarily logged in the memories of devices 16, 22, it is possible that social network sites 47, 46 could look at that history. Further, if social network site 47 has a buying history associated with user profile and database 54A, that buying history, in addition to the Internet search history could be used to identify the personality type of the user. In step 222, information regarding the user is gathered as well as the user profile data. In step 224, the user's search-buy data from devices 16, 22 and “buy” information from social network site 47, 80 is compiled. In step 226, a match from the Internet search history and the buy history is matched to a personality profile pattern. This is provided based upon various Enneagram tests discussed above in connection with Table E-1 and Tables EE-1 through EE-5. In step 228, personality profile typing and Ph-M data is matched to the user. This Ph-M data is then logged into user database 81, 54A, 54B and potentially 83. In step 230, this data is distributed to the database identified earlier.

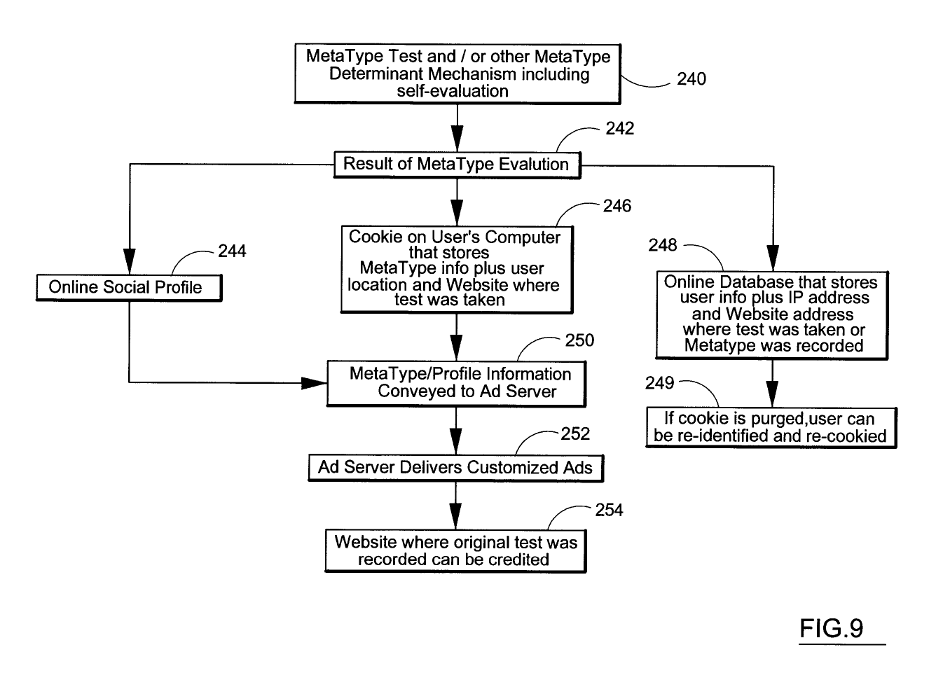

FIG. 9 graphically illustrates certain aspects of the present invention at a vary high level. Step 240 engages the user with a meta-type or personality test. Other personality type determining mechanisms can be used in addition to the self evaluation test. In step 242, the test result is provided and evaluated. The test results and Ph-M data are loaded into on line social profiles 244. Step 246 loads a cookie on the user's computer 16, 22 that is unique to the personality profile of the user. Further, the website where the test was taken may be loaded as a cookie or identifier on devices 16, 22. Step 248 distributes that data to online databases including the user's I.P. address, the test taken website and the personality type identified by the test. In step 249, if the user deletes the cookie, the user can be re-identified potentially by the I.P. address or the cell phone ANI and then the user's devices 16, 22 can be reloaded or re-cookied with the personality type. In step 250, the personality profile is conveyed to ad server 82. In step 252, the ad server delivers customized personality type ads to any particular user activating devices 16, 22. In step 254, the site of the original test is recorded and rewarded by the inventive program discussed earlier.

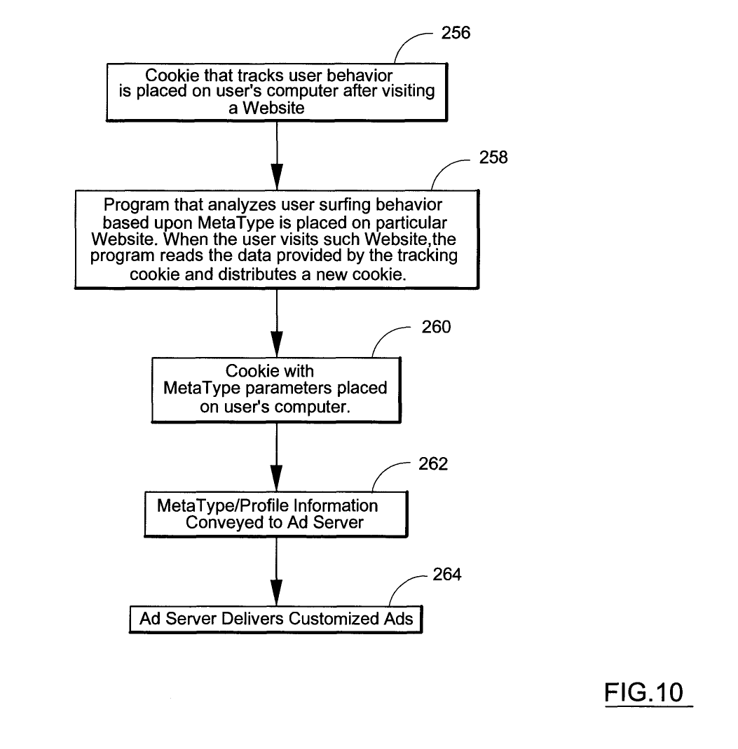

FIG. 10 diagrammatically illustrates the utilization of personality type data to deliver ads. In step 256, the cookie is placed on the user's computer after visiting the website. The cookie is a personality type cookie. In step 258, the website that the user is currently visiting monitors the user's personality type or meta-type and when the user visits the website, the program on the website reads the data from the cookie and distributes a new cookie. In step 260, the cookie with the meta-type parameter is placed on the user's computer. In step 262, the ad from the ad server 82 recognizes the cookie and in step 264, a personality type ad is delivered to user on devices 16, 22.

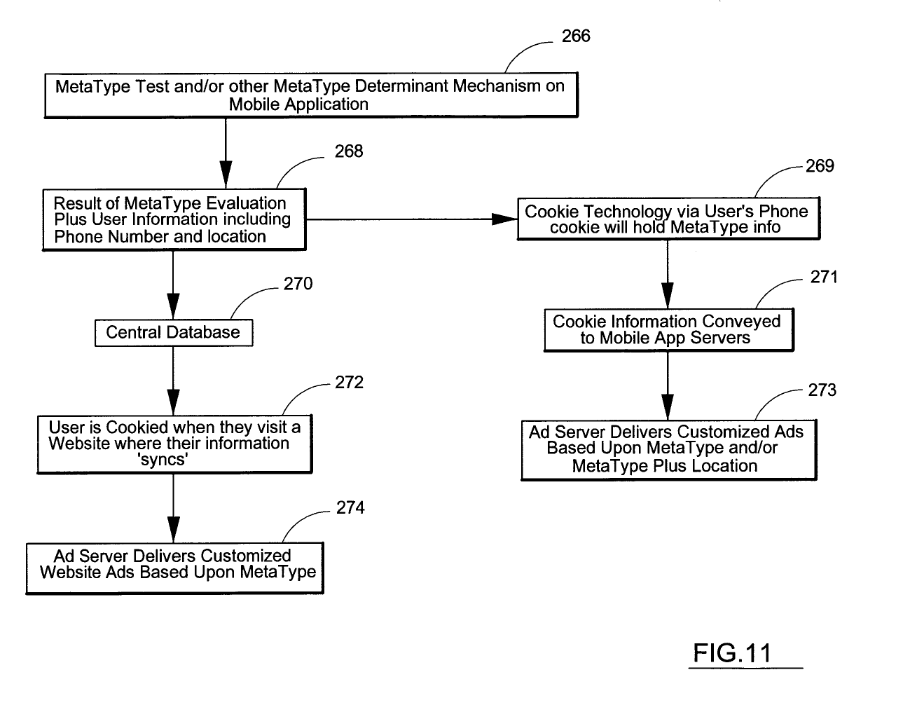

FIG. 11 diagrammatically illustrates the use of personality type ads delivered to cell phone 16. In step 266, the personality of the user is obtained from cell phone 16 by mobile applications. This may include verbal test or may include visual test or a combination of verbal and audio (AV) test. In step 268, the personality results are obtained along with the cell phone number or ANI. The geographic location or geo data is also obtained from cell phone 16. Step 269 loads a cookie into the cell phone if available. Step 271 has that cookie tracked when the user at cell phone 16 visits various websites 47, 46, 80, 84. In step 273, ad server 82 delivers personality type ads to the cell phone user at device 16. After engaging the personality test in step 268, the central database is updated in step 270. As noted above, these databases include databases 54A, 54B, 81 and potentially 83. In step 272, the user's device 16 is uploaded with a cookie and then any website 84 sends their information from the cookie in the cell phone ANI. In step 274, the ad server 82 delivers a customized or a personality type ad to the user at cell phone 16.

### System Components

It is important to know that the embodiments illustrated herein and described herein are only examples of the many advantageous uses of the innovative teachings set forth herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawings, like numerals refer to like parts or features throughout the several views.

The present invention could be produced in hardware or software, or in a combination of hardware and software, and these implementations would be known to one of ordinary skill in the art. The system, or method, according to the inventive principles as disclosed in connection with the preferred embodiments, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in the art.

According to the inventive principles as disclosed in connection with the preferred embodiments, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer as would be known to one of ordinary skill in the art. The computer medium which may be used to hold or contain the computer program product, may be a fixture of the computer such as an embedded memory or may be on a transportable medium such as a disk or CD, as would be known to one of ordinary skill in the art. Further, the program, or components or modules thereof, may be downloaded from the Internet of otherwise through a computer network.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, flash memory, floppy disk, disk drive memory, CD-ROM, and other permanent storage. Additionally, a computer readable medium may include, for example, volatile storage such as RAM, buffers, cache memory, and network circuits. A data store is any type of computer medium capable of storing digital data therein, that is, hard drives, flash drives, RAM, ROM, etc.

Furthermore, the computer readable medium may include computer readable information in a transitory state medium such as a network link and/or a network interface, including a wired network or a wireless network, that allow a computer to read such computer readable information.

In the drawings, and sometimes in the specification, reference is made to certain abbreviations. The following Abbreviations Table provides a correspondence between the abbreviations and the item or feature.

Abbreviations Table

| | |
|---|---|
| 3^{rd} Pty | third party |
| acct | account |
| ad | advertisement, typically with hyperlink to vendor |
| addr | address |
| ANI | automatic number identification unique to each cell phone |
| AV | audio-visual content includes all shared data, voice, audio, |
| | docs, images, video |
| AV | audio visual, typically AV presentation |
| cell no | cell phone number |
| cert | certificate of completion for LP |
| CD-RW | compact disk drive with read/write feature for CD disk |
| ck | check or confirm |
| comm | communication event or telecommunications system (where |
| | noted) |
| comm device | cell phones, PDAs, computers, telecom enabled devices |
| Cntr | Center, such as a Control Center (Cntlr Cntr) |
| cntrl | control |
| DB or db | data base |
| defn | defined, such as user defined parameter |
| disp | display, sometimes displ |
| distrib | distribution |
| doc | document |
| DS | data storage |
| e.g. | for example |
| E-test | some type of personality test delivered to Internet enabled |
| | device |
| em | email |
| encry | encryption |
| ex | example |
| extr | extrinsic or data outside the system |
| fnc | function, e.g., record function |
| geo | geographic location or code |
| gd | goods, such as branded goods |
| GPS | global positional system, typically GPS data |
| h-link | hyper link, an active web screen segment linking to another |
| | website or web site server |
| ID | identity |
| I-device | Internet enabled device, such as computer, cell phone |
| I/O | input/output |
| IVR | interactive voice response (human to and from computer) |
| kypd | keypad |
| log | a log of a rcd session, chronologic date-time stamp |
| mkt | market |
| mbr | member registered in system |
| mem | memory |
| mess | message as in SMS or text message |
| Mgr | manager, may be Sys. Op. |
| mgt | management |
| Mod | module, either software or hardware |
| n/a | not applicable |
| ntwk | network |
| obj | object, for example, a data object |
| ofc. | office |
| opt | optional |
| pgm | program |
| Ph-M | personality type meta data |
| profile | all data about a member in system |
| Pty | party, such as third party ad server |
| p/w | password |
| rcd | records, electronic data, personal profile data, Ph-M data |
| reg | registered as in Reg User or Reg Member (mbr), sometimes |
| | reg'd |
| rel | release |
| reqmt | requirement or protocol, may be optional |
| rqst | request |
| rev | review |
| rpt | report |
| rt | real time or within a reasonable, somewhat predictable time |
| | after the event |
| r-t | real time |
| sch | search |
| scrn | screen, as in touch screen computer enabled device |
| sec | security |
| seg | segment |
| sel | select |
| sess | Internet secession, audio, AV, mobile |
| SLA | service level access |
| soc. ntwk | social network |
| supple | supplement data, Ph-M test, user id |
| MI | system management interface |
| srvr | server |
| svr | server |
| std | standard |
| sys | system |
| Sys Op | system operator or system administrator |
| t | time, usually time period |
| t1, t2 | time, wherein t1 is prior to time t2 |
| telecom | telecommunications system or network |
| temp | temporary |
| trkr | tracker as in access tracker or geo tracker |
| unkn | unknown |
| URL | Uniform Resource Locator, x pointer, or other network |
| | locator, may be a mini-url for cell phone or PDA use |
| VOIP | voice over Internet Protocol |

The claims appended hereto are meant to cover modifications and changes within the scope and spirit of the present invention

What is claimed is:

1. An advertisement distribution system deployed over a plurality of Internet-enabled devices distributing ads from at least one of a plurality of servers to a user's Internet-enabled device comprising:
a data collection of ads grouped into personality profile types wherein either ads for the same goods have different content for different personality types or ads for different goods are grouped according to the different personality types;
a centralized or a distributed database storing a plurality of user ids and the corresponding personality type for each user associated with the respective user id;
means for uploading a personality type marker associated with said user's Internet-enabled device into said user's Internet-enabled device;
on a website server, means for recognizing the associated personality type marker upon interconnection with said user's Internet-enabled device;
means for triggering the display of an ad from the personality types ad group corresponding to the user's associated personality type.

2. An advertisement distribution system as claimed in claim 1 including:
means for interactively testing the personality of the user coupled to said user's Internet-enabled device;
a data distribution system for updating said database storing user ids and personality types.

3. An advertisement distribution system as claimed in claim 2 including a plurality of Internet connections between said data ad collection, said database storing user ids and personality types, said user's Internet-enabled device and said website server displaying the personality type ad.

4. An advertisement distribution system as claimed in claim 3 including a revenue monitor on said website server for tracking the triggering of the displayed ad, said revenue monitor coupled to said database storing user ids and personality types and providing ad tracking data thereto.

5. An advertisement distribution system deployed over a plurality of Internet-enabled devices distributing ads from at least one of a plurality of servers to a user's Internet-enabled device comprising:
a data collection of ads grouped into personality profile types wherein either ads for the same goods have different content for different personality types or ads for different goods are grouped according to the different personality types, said ads having either audio and video content or solely audio content;
a centralized or a distributed database storing a plurality of user ids and the corresponding personality type for each user associated with the respective user id, some of said plurality of user ids being cell phone unique identifiers;
on a server interconnected to the Internet, means for recognizing the associated personality type for the user upon interconnection with said user's Internet-enabled device;
means for triggering the presentation of an ad from the personality types ad group corresponding to the user's associated personality type.

6. An advertisement distribution system as claimed in claim 5 including:
means for interactively testing the personality of the user with one of a visually presented test and an audible test coupled to said user's Internet-enabled device; and
a data distribution system for updating said database storing user ids and personality types.

7. An advertisement distribution system as claimed in claim 6 including a revenue monitor on said server for tracking the triggering of the presented ad, said revenue monitor coupled to said database storing user ids and personality types and providing tracking data thereto.

8. A method for distributing advertisements to users on respective user Internet-enabled devices wherein said ads are personality grouped according to the different personality types comprising:
providing a collection of ads grouped into personality profile types wherein either ads for the same goods have different content for different personality types or ads for different goods are grouped according to the different personality types, said ads being electronically presentable on said Internet-enabled devices, said collection of ads maintained in an Internet connected data store;
generating a test and collecting results from a user's Internet-enabled device to determine the user's personality profile type and storing a user id and the associated user personality profile type in a user-personality profile database interconnected and maintained on the Internet;
downloading a personality type marker associated with said user's Internet-enabled device into said user's Internet-enabled device;
recognizing an associated personality type marker obtained from said user's Internet-enabled device when the user's device interacts with a website server over the Internet;
presenting an ad from the personality types ad group corresponding to the user's associated personality type.

9. A method for distributing advertisements to user Internet-enabled devices as claimed in claim 8 including:
providing a testing server accessed by said user via the user's Internet-enabled device wherein said testing server presents said test to said user's Internet-enabled device and collects results therefrom indicative of the user's personality profile type, said testing server interconnected to said user-personality profile database;
providing multiple data stores with ad collections grouped into personality profile types maintained and accessible on the Internet;
said website server being one of a plurality of website servers adapted to recognize associated personality types;
tracking which website server recognizes an associated personality types and generating a tracking report.

10. A method for distributing advertisements to user Internet-enabled devices as claimed in claim 9 monitoring the tracking reports and sharing revenue based upon the operations of said testing server, said user-personality profile database, and the website server recognizing the associated personality types.

11. A method for distributing advertisements to user Internet-enabled devices as claimed in claim 10 wherein said testing server is operable in a social network and said user-personality profile database is controlled by said social network.

12. A method for distributing advertisements to user Internet-enabled devices as claimed in claim 11 wherein said user-personality profile database includes personal identifying information of said user and the method includes accepting user generated data from said user's Internet-enabled device representing associated personal identifying information of said user and storing the same in a user's profile.

13. A method for distributing advertisements to user Internet-enabled devices as claimed in claim 12 including collecting Internet history data from said user's Internet-enabled device and updating said user's profile.

14. A method for distributing advertisements to user Internet-enabled devices as claimed in claim 13 presenting said ad form the personality types ad group during the presentation of a second web page displayed by said one website server.

15. A method for distributing advertisements to user Internet-enabled devices as claimed in claim 8 wherein said test is generated by said website server and the method includes forwarding the test results to said user-personality profile database.

16. A method for distributing advertisements to user Internet-enabled devices as claimed in claim 15 wherein said user-personality profile database includes personal identifying information of said user and the method includes
activating said user's Internet-enabled device;
accepting user generated data from said user's Internet-enabled device representing associated personal identifying information of said user and storing the same in a user's profile.

17. A method for distributing advertisements to user Internet-enabled devices as claimed in claim 8 wherein said user-personality profile database includes personal identifying information of said user and the method includes:
activating said user's Internet-enabled device;
accepting user generated data from said user's Internet-enabled device representing associated personal identifying information of said user and storing the same in a user's profile.

18. A computer readable medium containing non-transitory programming instructions for distributing advertisements to users on respective user Internet-enabled devices wherein said ads are personality grouped according to the different personality types, comprising:
providing a collection of ads grouped into personality profile types wherein either ads for the same goods have different content for different personality types or ads for different goods are grouped according to the different personality types, said ads being electronically presentable on said Internet-enabled devices, said collection of ads maintained in an Internet connected data store;
generating a test and collecting results from a user's Internet-enabled device to determine the user's personality profile type and storing a user id and the associated user personality profile type in a user-personality profile database interconnected and maintained on the Internet;
downloading a personality type marker associated with said user's Internet-enabled device into said user's Internet-enabled device;
recognizing an associated personality type marker obtained from said user's Internet-enabled device when the user's device interacts with a website server over the Internet;
presenting an ad from the personality types ad group corresponding to the user's associated personality type.

19. A computer readable medium containing non-transitory programming instructions for distributing advertisements to user Internet-enabled devices as claimed in claim 18 including:
providing a testing server accessed by said user via the user's Internet-enabled device wherein said testing server presents said test to said user's Internet-enabled device and collects results therefrom indicative of the user's personality profile type, said testing server interconnected to said user-personality profile database;
providing multiple data stores with ad collections grouped into personality profile types maintained and accessible on the Internet;
said website server being one of a plurality of website servers adapted to recognize associated personality types;
tracking which website server recognizes an associated personality types and generating a tracking report.

20. A computer readable medium containing non-transitory programming instructions for distributing advertisements to user Internet-enabled devices as claimed in claim 19 monitoring the tracking reports and sharing revenue based upon the operations of said testing server, said user-personality profile database, and the website server recognizing the associated personality types.

21. A computer readable medium containing non-transitory programming instructions for distributing advertisements to user Internet-enabled devices as claimed in claim 20 wherein said testing server is operable in a social network and said user-personality profile database is controlled by said social network.

22. A computer readable medium containing non-transitory programming instructions for distributing advertisements to user Internet-enabled devices as claimed in claim 21 wherein said user-personality profile database includes personal identifying information of said user and the method includes accepting user generated data from said user's Internet-enabled device representing associated personal identifying information of said user and storing the same in a user's profile.

23. A computer readable medium containing non-transitory programming instructions for distributing advertisements to user Internet-enabled devices as claimed in claim 22 including collecting Internet history data from said user's Internet-enabled device and updating said user's profile.

24. A computer readable medium containing non-transitory programming instructions for distributing advertisements to user Internet-enabled devices as claimed in claim 23 presenting said ad form the personality types ad group during the presentation of a second web page displayed by said one website server.

25. A computer readable medium containing non-transitory programming instructions for distributing advertisements to user Internet-enabled devices as claimed in claim 18 wherein said test is generated by said website server and the method includes forwarding the test results to said user-personality profile database.

26. A computer readable medium containing non-transitory programming instructions for distributing advertisements to user Internet-enabled devices as claimed in claim 25 wherein said user-personality profile database includes personal identifying information of said user and the method includes
activating said user's Internet-enabled device;
accepting user generated data from said user's Internet-enabled device representing associated personal identifying information of said user and storing the same in a user's profile.

27. A computer readable medium containing non-transitory programming instructions for distributing advertisements to user Internet-enabled devices as claimed in claim 18 wherein said user-personality profile database includes personal identifying information of said user and the method includes:
activating said user's Internet-enabled device;
accepting user generated data from said user's Internet-enabled device representing associated personal identifying information of said user and storing the same in a user's profile.
